(19) United States
(12) Patent Application Publication
(10) Pub. No.: US 2009/0282847 A1
(43) Pub. Date: Nov. 19, 2009

(54) Hot Box Chill Spray System and Method Of Its Use

(76) Inventors: Robert C. Bullard, Chattanooga, TN (US); Todd Faulk, Chattanooga, TN (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 12/122,086

(22) Filed: May 16, 2008

(51) Int. Cl. F25D 17/00; A23B 4/08

(52) U.S. Cl. 62/177; 62/310; 62/311; 99/517

(57) ABSTRACT

An improved chill water system for use with a hot box is discussed. In processing beef preferably a recirculation loop with a chill water system mixes anti-microbial solution in the chill water tank and adjusts concentration with a controller to add chemical treatment to the tank. Additionally, a supply water line to the chill water tank has a flow sensor linked to a controller which can control addition of treatment agent based on input water from the supply source.

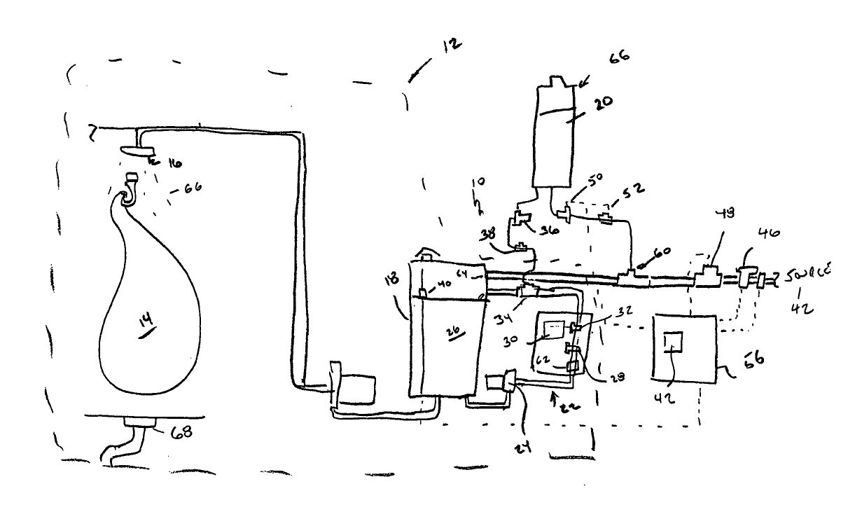

### FIELD OF THE INVENTION

The present invention relates to a system for use in applying anti-microbial agent with chill water systems utilized with hot boxes in beef processing, and more particularly to a system for maintaining a relatively precise concentration of anti-microbial agent in the chill water which is applied to beef carcasses in the hot box.

### DESCRIPTION OF RELATED ART

In the context of the beef processing plant, there is a need for cooling beef after evisceration. This cooling step is normally performed in a chiller often called a hot box. A chill water tank has been used in the prior art which may have chlorine added to it which is utilized to direct at the carcass (to at least one of assist in cooling or cleaning) and direct drippings and other contaminants towards drains which are then removed as waste.

A need is believed to exist for an improved chill water application system and method of its use.

### SUMMARY OF THE INVENTION

It is an object of the present invention to provide an improved chill water system for use with hot boxes in the beef processing industry.

It is another object of the present invention to provide a precise application of anti-microbial treatment to a beef carcass in a chiller.

It is another object of the present invention to provide a redundant system in at least one embodiment for providing anti-microbial treatment to beef carcasses.

In accordance with a presently preferred embodiment of the present invention, a chill water tank utilized in a chiller also known as a hot box is normally utilized to assist in cooling beef carcasses after evisceration. Specifically, the chill water tank is normally provided with an inlet from city water sources and an outlet.

The applicant is providing what is believed to be a novel recirculation loop to the tank which mixes solution in the tank, or at least assists in preventing chemical stratification, and takes solution from the tank to provide to at least one probe which monitors an amount of anti-microbial treatment chemical concentration in the tank. If the amount is less than a predetermined amount in a preferred embodiment, additional anti-microbial treatment chemical can be added to at least one of the recirculation loop and downstream of the probe and/or tank to increase concentration in the tank. Additionally, the chill water tank is preferably provided with a float switch such that when a level in the tank drops below a predetermined amount (as water is being discharged to the chill water tank outlet for application in the hot box), a flow meter in a make up supply line can provide a signal to a second controller so that the second controller can provide a signal to inject treatment chemical into the make up water supply and/or tank. In this manner, if either one of the two systems were to fail, anti-microbial agent would continue to be provided into the chill water tank for application to treat a carcass.

In other embodiments it is envisioned that it may be possible to utilize one, the other, or both chemical treatment addition systems.

### BRIEF DESCRIPTION OF THE DRAWINGS

The particular features and advantages of the invention as well as other objects will become apparent from the following description taken in connection with the accompanying drawings in which:

The FIGURE is a schematic of a portion of a hot box chill water system in accordance with a presently preferred embodiment of the present invention.

### DETAILED DESCRIPTION OF THE DRAWING

The FIGURE shows a chill water system 10 used in conjunction with a chiller or hot box 12. Beef carcass 14 is one of a plurality that would normally be in hot box 12 being cooled. Chill water is dispensed from spray head or outlet 16 in most beef processing plants regularly to assist in cooling carcass 14 and/or removing debris or other material which would otherwise contaminate carcass 14 and/or the hot box or chiller 12. In prior art operations, a chill water tank 18 may have been provided with city water and possibly had chlorine added thereto.

However, the applicant has discovered that adding anti-microbial treatment agent 65 from at least one source 20 such as a tank to the fill tank 18 in at least one of two presently preferred processes which may be utilized together to possibly provide a redundant system in at least some embodiments.

Chill water tank 18 is shown with a recirculation loop 22 which is not known by the applicant to have ever been provided with a chill water tank 18 used with a hot box 12 in a chill water system 10. The recirculation loop 22 may or may not have pump 24. The loop 22 if utilized recirculates chill water 26 in the tank 18 which may assist in maintaining chemicals in solution at a desired concentration as will be discussed below and/or to prevent stratification of chemicals within the tank 18. Additionally, the recirculation loop 22 of the preferred embodiment has at least one first sensor 28 which preferably monitors corrosion with a corrosion coupon rack which advises controller 30 of status of corrosion in pipes in the system.

Probe 32 preferably provides a signal to the controller 30 related to a concentration of treatment chemical 20 in the chill water 26 which is being recirculated through the recirculation loop 22. Controller 30 may at least assist in controlling the addition of treatment chemical 20 at addition point 34 such as by providing signals to operate pump 36 and/or valves 38 to provide chemical from added chemical tank 22 to the insertion point 34 based at least partially from signals from probe 32 to provide a relatively precise concentration of treatment agent 65 in tank 26. Addition point 34 could be within tank 18 or elsewhere in other embodiments.

The particular chemical utilized in a presently preferred embodiment is Microtox™ which is a buffered paracetic acid. Probe 32 measures the concentration of paracetic acid (PAA) in solution in this embodiment. Probe 32 or other probes may measure for other treatment chemicals in tank 18. The controller 30 can maintain a range of treatment chemicals as desired such as in a range of 15-45 ppm although a narrower range such as 30±5 ppm may be maintained relatively easily with the controller 30 and a metering pump 36 with or without valve 38. It is preferable that pump 24 be continuously run so that solution is continually recirculated through loop 22 which is believed to assist in mixing of treatment chemical 65 solution in the fill tank 26.

Most chill tanks 18 are on the order of 2,000 or 3,000 gallons, but most hot boxes 12 use approximately 100,000-300,000 gallons of water a day. Accordingly, one skilled in the art can see that the tank 18 is relatively regularly refilled. Level sensor 40 such as a float valve provides information to the controller 42 which causes water to flow from source 42 such as city water. Flow meter 46 has at least one of a pulse signal and an analog signal which is provided to controller 42 relative to flow from the source in the tank 18. The controller 42 operates valve 48 to initiate flow upon receiving a signal from level detector 40 to begin filling the tank 18. Meanwhile, controller 42 also sends a signal to at least one of pump 50 and valve 52 to begin introduction of treatment chemical from tank 20 so that as water is fed into the tank 18, it is treated chill water 26. Alternatively, in other embodiments, treatment chemical could be introduced into tank 18 directly or otherwise. Operation of value 48 could also trigger chemical addition in other embodiments.

In a presently preferred operation, an analog signal provided from flow meter 46 is a contacting water meter with a 4-20 ma output. The controller 42 may be located preferably in a cabinet 56 which tracks the quantity of water fed through flow meter 46 and thus into tank 18. The controller 42 may activate the insertion of additive from tank 20 at insertion point 60 and is preferably based on the amount of water flowing into tank 18 from the source 42. A data logging device which may be at least a portion of the controller 42 may be an Advantage Control Megatron. Other controllers which the applicant believes could be suitably utilized include a Pulsafeeder MBC series controller, Lakewood Model 161 or higher, Prominet Dulcameter, LMI 4500, Aqua Trak 100 series or above, the Walchem cooling tower controller or other suitable controllers.

Controller 30 used with recirculation loop 22 could be a Prominet Dulcameter and may also be in a cabinet. Other controller models could be utilized in other embodiments. Controller 30 preferably cooperates with a flow meter 62 and/or probe 32. A recirculation pump 24 operates continuously but interval operation could be performed in other embodiments.

The controllers 30, 42 may operate similarly or dissimilarly. A set point such as 30 ppm could be set for controller 30 so that the controller 30 will evaluate the concentration of 30 ppm and if less than 30 ppm may at least assist in the introduction of agent 65 at insertion point 34. Eventually as the water is being constantly introduced into the tank 26 or removed therefrom, the concentration can be relatively precisely maintained at 30±5 ppm in operation. Even with the addition of water into tank 18, the concentration can be relatively precisely maintained, particularly if information from flow meter 46 or other flow meters or other information is provided to the controller 30.

With the controller 30 set at a point such at 30 ppm it may be possible that controller 42 at a different point such as 25 ppm of intended concentration as water enters tank 18 at inlet 64 so that the controllers 30, 42 can effectively work together to maintain addition of treatment chemicals 20 from tank 20 or other source of treatment chemicals 66.

Providing treated water 26 into fill tank 18, spray 66 can provide microbiological intervention as well as keep the floors and room clean from biological growth as the waste is removed from one or more drains 68 from the hot box 12.

If the first controller 30 were to fail, then controller 42 probably would maintain the treated water 26 and fill tank 18 at its said desired operating range such as at least about 25 ppm as discussed above. If controller 42 are failed, then the controller 30 could maintain the desired concentration in tank 18 particularly if flow meter 46 provides the input to controller 30. Of course, probe 32 or other sensor could also provide a signal to controller 42 and in an effort to maintain a more precise control of the concentration of treated water 26 in tank 18 particularly if controller 30 were to fail.

Although redundancy is certainly utilized in the presently preferred embodiment, use of recirculation loop 22 alone is believed to be novel as are the use of a controller to attempt to maintain a relatively precise concentration of treated chemical in tank 18 by the addition of chemical as water is fed from a traditional source such as city water.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A chill water system for use with a beef processing chiller comprising:
a chill water tank having an inlet receiving solution from a source, an outlet directing solution onto beef carcasses in an interior of the beef processing chiller, and a recirculation loop directing solution from the tank past a sensor and back into the tank.

2. The chill water system of claim 1 wherein solution is continuously directed through the recirculation loop.

3. The chill water system of claim 2 further comprising a pump in the recirculation loop.

4. The chill water system of claim 1 further comprising a controller in communication with the sensor, said controller providing a signal which at least assists in the selective addition of an anti-microbial treatment agent to the solution.

5. The chill water system of claim 4 wherein the treatment agent is added in the recirculation loop downstream of the sensor.

6. The chill water system of claim 4 wherein the treatment agent comprises paracetic acid.

7. The chill water system of claim 6 wherein the controller at least partially assists in maintaining a paracetic acid concentration of about 10 to about 45 ppm in solution.

8. The chill water system of claim 1 further comprising a sensor intermediate the source and the inlet of the chill water tank, said sensor providing an input relative to an amount of water flowing from the source to the chill water tank, and an amount of treatment agent proportionally dosed relative to the amount of water provided to the chill water tank added at an insertion point intermediate the source and the chill water tank.

9. The chill water system of claim 8 further comprising a controller receiving the input relative to the flow of water to the chill water tank and providing an output to at least assist in dosing the treatment agent added relative thereto.

10. The chill water system of claim 9 wherein the insertion point is located external to the chill water tank.

11. A chill water system for use with a beef processing chiller comprising:
a chill water tank having an inlet receiving solution from a source, an outlet directing solution onto beef carcasses in an interior of the beef processing chiller, and a recirculation loop directing solution from the tank past a sensor; and
a controller in communication with the sensor with said controller selectively providing an output based on input related to output from the sensor, with the output of the controller at least assisting in providing anti-microbial treatment agent to the solution.

12. The chill water system of claim 11 wherein the solution from the recirculation loop is directed back into the tank and the treatment agent is added to the recirculation loop downstream of the sensor and prior to directing the solution back into the tank.

13. The chill water system of claim 12 wherein the treatment agent comprises peracetic acid and the controller at least assists in maintaining a range of about 10 to about 45 ppm in the solution in the tank.

14. The chill water system of claim 13 further comprising a pump in the recirculation loop.

15. The chill water system 12 further comprising a second sensor intermediate the source and the inlet of the chill water tank, said second sensor providing an input relative to an amount of water flowing from the source to the chill water tank, and an amount of treatment agent proportionally dosed relative to the amount of water provided to the chill water tank added at an insertion point intermediate the source and the chill water tank.

16. The chill water system of claim 15 wherein the treatment agent added to the water from the source is added at a lower concentration than the controller has a setting directing the addition of agent to a higher concentration.

17. The chill water system of claim 15 further comprising a controller receiving the input relative to the flow of water to the chill water tank and providing an output to at least assist in dosing the treatment agent added relative thereto.

18. The chill water system of claim 17 wherein the insertion point is located external to the chill water tank.

19. A chill water system for use with a beef processing chiller comprising:
a chill water tank having an inlet receiving solution from a source, an outlet directing solution onto beef carcasses in an interior of the beef processing chiller; and
a sensor intermediate the source and the inlet of the chill water tank, said sensor providing an input relative to an amount of water flowing from the source to the chill water tank, and an amount of anti-microbial treatment agent proportionally dosed relative to the amount of water provided to the chill water tank added at an insertion point intermediate the source and the chill water tank.

20. The chill water system of claim 19 wherein the recirculation and a recirculation loop directing solution from the tank past a sensor and back into the tank, and
at least one controller receiving an input from at least one of the sensor with the recirculation loop and the sensor intermediate the source and the chill water tank, said at least one controller providing at least one signal which at least assists in maintaining concentration of anti-microbial treatment agent in solution.
